(19) United States
(12) Patent Application Publication
(10) Pub. No.: US 2024/0253170 A1
(43) Pub. Date: Aug. 1, 2024

(54) LINEAR OR ROTARY TABLE MOVABLE IN TWO DIMENSIONS

(71) Applicant: PHYSIK INSTRUMENTE (PI) GMBH & CO. KG, Karlsruhe (DE)

(72) Inventors: Burhanettin KOC, Ettlingen (DE); Simon KAPELKE, Karlsruhe (DE)

(21) Appl. No.: 18/290,374

(22) PCT Filed: May 16, 2022
(86) PCT No.: PCT/EP2022/063201

§ 371 Date: Nov. 13, 2023

(30) Foreign Application Priority Data
May 17, 2021 (DE) 10 2021 112 720.3

(51) Int. Cl. B23Q 1/50; H02N 2/02; H02N 2/10

(52) U.S. Cl. CPC B23Q 1/50; H02N 2/025; H02N 2/028; H02N 2/101; H02N 2/108

(57) ABSTRACT

A linear or rotary table is provided which can be moved in two dimensions having a stator and at least one upper slider plate movable relative to the stator in two independent translational directions or two independent rotary directions, and at least two piezoelectric linear drives for moving the upper slider plate in the two translational directions or two rotary directions, wherein a central slider plate is arranged between the stator and the upper slider plate, and the at least two piezoelectric linear drives are each attached to the stator to move the upper slider plate in the two translational directions or two rotary directions, and wherein at least one piezoelectric linear drive attached to the stator is in contact with the upper slider plate through an opening in the central slider plate to move the upper slider plate in a first translational direction or a first rotary direction.

### CROSS REFERENCE TO RELATED APPLICATIONS

This application is a U.S. National Phase Application under 35 U.S.C. 371 of International Application No. PCT/EP2022/063201, filed on May 16, 2022, which claims priority to German Patent Application No. 10 2021 112 720.3, filed on May 17, 2021. The entire disclosures of the above applications are expressly incorporated by reference herein.

### TECHNICAL FIELD

The present invention relates to a linear or rotary table movable in two dimensions having a stator and at least one upper slider plate movable relative to the stator in two independent translational directions or two independent rotary directions, and at least two piezoelectric linear drives for moving the upper slider plate in the two translational directions or two rotary directions.

### BACKGROUND

Such linear tables, rotary tables or tilting tables movable in two dimensions are simple and accurate positioning and handling systems used not only in research and development, but also in industry in processing and production. Their use ranges from industrial conveyor systems for the exact alignment of transported products for subsequent product identification, labeling, marking and packaging, to the high-precision positioning of devices or samples in research and development. Most importantly, such linear, rotary or tilting stages are characterized by accurate motion having low friction and deformation-free absorption of lateral forces. The use of piezoelectric linear drives enables the slider plate to be moved without a mechanical transmission of the drive, resulting in a fast response speed and high stiffness and dynamics of the drive. Here, due to the linear movement direction of such piezoelectric linear drives, i.e. the forward and backward movement along a spatial axis, at least two piezoelectric linear drives are required for positioning the slider plate in two independent translational or two independent rotary movement directions. The movement of the upper slider plate in two independent translational or two independent rotational directions refers to the movement directions of a rigid body in space in the direction of the six possible degrees of freedom, i.e. in three independent translational directions and three independent rotational directions around three independent axes, back and forth respectively.

For the movement of linear or rotary tables in two independent translational or two independent rotary directions, the tables are divided into several planes and the layers are arranged one above the other. Typically, a linear or rotary table movable in two dimensions has three layers, wherein the upper layer is the upper slider plate on which products or elements to be transported are arranged, and wherein the middle layer is a combination of a stator of the upper movement plane and a slider of the lower movement plane, and the linear drive of the upper movement plane is positioned on this middle layer, and wherein the lower layer finally forms the base plate or stator of the lower movement plane. When a piezoelectric linear drive of the lower motion plane positioned on the base plate moves the slider plate of the central layer in an independent direction, the second piezoelectric linear drive positioned thereon and the upper slider plate moved by it in a second independent direction also move with this central slider plate. Together with having the second piezoelectric linear drive mounted on the central slider plate, the connecting cables for supplying the second linear drive must also move. Especially in applications having a very high accuracy for exact positioning of elements in the nanometer range, a very high linearity of the movement of the upper slider plate and a high long-term stability of the positioning accuracy and movement linearity, the connecting lead for the second piezoelectric linear drive can interfere with the movement of the central slider plate in the lower movement plane, especially depending on the stiffness of the connecting lead. Therefore, in linear or rotary tables having high requirements for accuracy of positioning and stability of linearity of motion, for the connection of the second piezoelectric linear drives, line tapes are used which have almost negligible stiffness in the movement direction of the lower plane of motion.

The present invention is therefore based on the task of providing a linear or rotary table movable in two dimensions having the highest accuracy of positioning and outstanding linearity of motion.

### SUMMARY

According to the present invention, this task is solved by providing a central slider plate, wherein the central slider plate is arranged between the stator and the upper slider plate, and in that the at least two piezoelectric linear drives, each moving the upper slider plate in one of two independent translational directions or two independent rotary directions are each attached to the stator for moving the upper slider plate in one of the two translational or two rotational directions, and wherein at least one piezoelectric linear actuator attached to the stator is in contact with the upper slider plate through an opening in the central slider plate for moving the upper slider plate in a first translational or rotational direction. In this regard, these at least two piezoelectric linear drives are independent of each other and configured as completely separate linear drives. The arrangement of all piezoelectric linear drives for the 2-dimensional movement of the upper slider plate on the base plate or the stator of the linear or rotary table makes it possible to dispense with a movable connecting line for the second linear drive and thus avoids even the slightest interference with the positioning and movement linearity of the upper slider plate.

The provision of a central slider plate and its arrangement in a plane of motion between the stator and the upper slider plate enables a structurally simple design of a linear or rotary table according to the invention. In this case, the central slider plate and the upper slider plate are arranged such that they move together in a second translational or rotational direction relative to the stator, and the upper slider plate moves relative to the central slider plate only in the first translational or rotational direction. To this end, a second piezoelectric linear actuator attached to the stator can either be in contact with the central slider plate to move the central slider plate directly and the upper slider plate indirectly in the second translational or rotational direction, or alternatively be in contact with the upper slider plate directly through the opening in the central slider plate to move the upper slider plate directly and the central slider plate indirectly in the second translational or rotary direction.

Although the at least two piezoelectric linear drives can each move in only one linear movement direction, the embodiment according to the invention makes it possible to have linear or rotary tables movable in two dimensions with a positional accuracy in the sub-nanometer range and the highest movement linearity with good long-term stability. In this case, the two piezoelectric linear drives are preferably spring-mounted relative to the slider plate to ensure reliable transmission of the motion in the two independent translational or rotary directions to the upper slider plate.

Expediently, the at least two piezoelectric linear drives attached to the stator are arranged at an angle to each other and are preferably arranged at an angle of 90° to each other. The arrangement of the at least two piezoelectric linear drives at an angle to one another, wherein the orientation of the arrangement of the piezoelectric linear drives on the stator corresponds in each case to the direction of movement of the linear drives, in particular to the axes of the two independent translational directions or perpendicular to the axes of the two independent rotational directions, enables reliable, slip-free transmission of the movement of the piezoelectric linear drives arranged on the stator to the upper slider plate.

In a preferred embodiment, a guide of the upper slider plate is provided to guide the upper slider plate relative to the stator in at least one, preferably in two translational or rotary directions. Such guiding of the upper slider plate in the direction of movement of the upper slider plate enables accurate positioning and linearity of movement of the upper slider plate and, at the same time, high stability of the linear or rotary table movable in two dimensions.

In a useful embodiment, a guide is provided between the stator and the central slider plate and between the central slider plate and the upper slider plate, respectively, to guide the upper slider plate relative to the stator in at least two independent translational or rotary directions. Such guidance in the direction of the two independent translational or rotational movement directions of the central slider plate and the upper slider plate, respectively, ensures accurate positioning and alignment of the upper slider plate and improves the stability of the linear or rotary table according to the invention.

A favorable version provides that the guides between the stator and the central slider plate and/or the guide between the central slider plate and the upper slider plate are configured as guide rails, wherein the guide rails are preferably provided on two opposite sides of the stator and/or the central slider plate and/or the central slider plate and/or the upper slider plate, respectively. This enables a particularly rigid design and thus unchanged high positioning and repeat accuracy even at higher dynamics and fast response speeds.

Furthermore, it is advantageous if the upper slider plate and/or the central slider plate has a resilient force absorbing device for absorbing a driving force of the piezoelectric linear actuators. Such a resilient force absorbing device allows easy maintenance and replacement of the force absorbing device without disassembling the at least two piezoelectric linear drives attached to the stator. Further, such a resilient force absorbing device allows for selective adjustment of a static friction between the piezoelectric linear drive and the upper slider plate and/or the central slider plate.

In a useful design, the at least two piezoelectric linear actuators are configured as at least two piezoelectric frictional contact actuators. Frictional contact actuators allow safe movement of the central slider plate and the upper slider plate in the two translational or rotary directions. In this context, the at least two piezoelectric frictional contact actuators can each have at least one actuating element configured as a frictional element, wherein the frictional elements are in frictional contact with the central slider plate or with the central slider plate and the upper slider plate in order to move the upper slider plate in the two translational directions or two rotational directions. Such friction elements can be pressed in a simple manner against the upper slider plate or the upper and central slider plates to allow, by means of a simple design, safe movement of the central slider plate and the upper slider plate in the two translational or rotary directions. In addition, such frictional contact actuators have the advantage of holding the current position of the corresponding slider plate in the energy-free state by virtue of the existing frictional contact with the slider plate and thus have a self-locking effect.

One particular embodiment provides that the at least two piezoelectric linear drives are configured as at least two encapsulated piezoelectric linear drives, and in particular are configured as encapsulated piezoelectric inertial or resonant drives. Such encapsulated piezoelectric linear drives enable protection of the actual actuators comprising an electromechanical material, which are deformed by electrical actuation in order to generate a linear movement of the drive, from environmental influences within the linear or rotary table according to the invention. In particular, the sensitive contact points between the electrodes of the piezoelectric linear drives and the actual actuators are not contaminated by moisture, dust, abrasion or lubricants. As a result, there is significantly less wear or abrasion at these contact points, which significantly increases the service life of the piezoelectric linear drives and thus of the linear or rotary table.

Advantageously, the encapsulated piezoelectric linear drives can comprise a housing, at least two actuators arranged inside the housing and having an electromechanical material, each of which generates a deflection when excited having an electrical control voltage, and a driving element arranged outside the housing, wherein an elastic wall portion of the housing, which is elastically deformed by the deflection of the actuators, couples the actuators and the actuating element to each other such that the driving element is set in motion by the deflection of the actuators. The elastic wall section of the housing is thereby elastically deformed by the deflection of the actuators. The elastic wall section, which can be designed as a diaphragm, for example, allows the protective function of the housing to be retained without restriction on the one hand, while on the other hand the deflection generated by the actuators is transmitted directly to the actuating element of the encapsulated piezoelectric linear drive arranged outside the housing. In this context, it is advantageous if the actuating element is resiliently preloaded relative to the actuators with the interposition of the elastic wall section of the housing. The resilient pretensioning keeps both the actuators and the actuating element in close and direct contact with the elastic wall section. The force transmission between the actuators and the actuating element is thus indeed indirect, but nevertheless direct, and largely eliminates interfering influences.

A useful embodiment provides that the housing consists of two or more housing parts, wherein the housing parts are preferably connected to one another with the interposition of at least one sealing element, in particular are connected to one another in a hermetically sealed manner, wherein the sealing element preferably consists of epoxy resin, an adhesive or a rubber-elastic material. This allows the various housing parts to be connected or disconnected as required when the actuators are installed in or removed from the housing, wherein the actuators are frictionally fixed in the housing in a closed state of the housing, preferably clamped between the interconnected housing parts.

A preferred embodiment provides that a first housing part is configured as a preferably planar plate and a second housing part is configured as an open hollow body closable by the planar plate and having a cavity for receiving the actuators, wherein preferably the open hollow body comprises the elastic wall portion aligned parallel to the first housing part in an enclosed state of the housing. This allows the two housing parts to be optimally sealed to each other, in particular by a simple sealing ring. Further, the planar plate is ideally suited for mounting or embedding flat conduit structures, while the open hollow body has its own spatial stability and forms a corresponding mechanical protection function for the actuators. This also applies in particular to the elastic wall section, which is expediently configured as part of the hollow body. In addition, a heat sink can also be provided in such a design, for example as part of the planar plate, in order to safely dissipate the waste heat generated when the actuators are deflected from the housing.

Another embodiment provides that the encapsulated piezoelectric linear drives have an electrical conductor structure with connection points on the inside housing side and connection points on the outside housing side, which are connected by conductor paths, wherein the actuators are electrically connected to the connection points on the inside housing side, preferably by electrically conductive adhesive, wherein the connection points on the outside housing side are preferably configured for fixed connection to a control device for controlling the actuators. Alternatively, the connection to a control device can also be connected by a flexible printed circuit board or electrically conductive pins for a sliding contact to a busbar. The electrical conductor structure can be worked out, for example by etching, from an electrically conductive foil previously applied to a housing plate. Such conductor structures are very flat and can run through a sealing plane on a hermetically sealed surface. A planar plate with such an applied electrical conduction structure is particularly suitable as a first housing part, wherein the actuators mounted on such a printed circuit board can be covered by an open hollow body with elastic membrane configured as a second housing part.

It can be advantageous if the inside housing connection points and the outside housing connection points and, if applicable, the conductor paths extend in the same plane, preferably on a side of the first housing part facing the second housing part. In this context, it is useful if the conductor structure is fixedly connected to the housing, in particular to the first housing part, since in this design protruding conductor wires or connection points, which are difficult to accommodate when space is limited, are avoided.

In a practical embodiment, the encapsulated piezoelectric linear drives include a support and spring means urging the housing against the support, wherein the actuating element is preferably disposed on the spring means. In this form of linear or rotary table according to the invention, the actuators accommodated by the housing of the piezoelectric linear drives and the actuating element of the piezoelectric linear drives driven by the actuators are securely positioned relative to one another.

Usefully, the support and the spring device can form a frame enclosing the housing, wherein the spring device is preferably configured as a spring element spanning the housing. The spring element can be connected to the support either on one side or on both sides of the housing. This particular design and arrangement of a spring element enables a particularly compact and stable design of a piezoelectric linear drive for a linear or rotary table.

Furthermore, the present invention relates to a method for moving a linear or rotary table movable in two dimensions, preferably according to one of the previously described embodiments. In this regard, the linear or rotary table comprises a stator, at least one upper slider plate moving relative to the stator in two independent translational directions or two independent rotary directions, a central slider plate disposed between the stator and the upper slider plate, and at least two, preferably four, piezoelectric linear drives attached to the stator, for moving the upper slider plate in the two translational directions or two rotational directions, wherein at least one piezoelectric linear drive attached to the stator is in contact with the upper slider plate through an opening in the central slider plate and moves the upper slider plate in a first translational direction or a first rotary direction, and wherein, for moving the upper slider plate in one or in both independent translational directions or in one or both independent rotary directions, the individual motion contributions of all piezoelectric linear drives attached to the stator are added or subtracted according to the signs of the motion contributions. Such a method enables reliable, slip-free transmission of the individual motion contributions of the piezoelectric linear drives arranged on the stator to the upper slider plate. It is particularly preferred that two piezoelectric linear drives attached to the stator are in contact with the upper slider plate through the opening in the central slider plate in order to move it in a first translational direction or a first rotary direction.

In this context, it may be advantageous if the at least two, preferably four, piezoelectric linear drives attached to the stator are inclined at an angle, preferably at an angle of 45°, to the two translational directions or to the projections of the two rotational directions in the stator plane, wherein for moving the upper slider plate in one of the independent translational directions or in one of the independent rotary directions, all piezoelectric linear drives attached to the stator provide a substantial positive or negative motion contribution. By electrically exciting all of the piezoelectric linear drives to move the upper slider plate in only one translational or rotary direction, the frictional inhibition between the actuating element of an unactuated piezoelectric linear drive and the upper slider plate that would otherwise occur during start-up and during motion can be prevented or at least significantly reduced.

Alternatively, in a method for moving a linear or rotary table movable in two dimensions, in which the at least two, preferably four, piezoelectric linear drives attached to the stator are arranged parallel to the two translational directions or to the projections of the two rotary directions into the plane of the stator, and in which at least one piezoelectric linear drive, which does not provide a motion contribution for moving the upper slider plate in exclusively one of the independent translational directions or in exclusively one of the independent rotary directions, the at least two actuators of this at least one piezoelectric linear drive are controlled having the same voltage signal, preferably a sinusoidal or sawtooth voltage signal, i.e. having an in-phase control of the two mutually opposing actuators, in order to reduce the friction inhibition occurring between the drive element of this one piezoelectric linear drive and the upper slider plate during starting and during the movement.

### BRIEF DESCRIPTION OF THE DRAWINGS

In the following, non-limiting embodiments of the invention are explained in detail with reference to exemplary drawings. They show:

FIG. 1 is a perspective exploded view of various components of a drive device of a piezoelectric linear drive for a linear or rotary table according to the invention,

FIGS. 2(a) and 2(b) are perspective views of an assembly of the drive device of FIG. 1, wherein the actuators of the drive device are arranged on a planar housing plate having a conductive structure, wherein FIG. 2(a) shows the assembly from a first side and FIG. 2(b) shows the assembly from a second side,

FIGS. 3(a) and 3(b) are perspective views of the drive device of FIG. 1, wherein the actuators are received in the housing, wherein FIG. 3(a) shows a perspective sectional view of the assembly and FIG. 3(b) shows a perspective side view of the assembly including an attached flexible printed circuit board,

FIG. 4 is a perspective exploded view of a piezoelectric linear drive having the drive device of FIG. 1,

FIGS. 5(a) and 5(b) are perspective views of the piezoelectric linear drive of FIG. 4 in an assembled state, wherein FIG. 5(a) shows a perspective side view of the piezoelectric linear drive and view FIG. 5(b) shows a perspective sectional view of the piezoelectric linear drive from a similar viewing direction,

FIGS. 6(a) and 6(b) are various sectional views of a conventional linear table movable in two dimensions, wherein FIG. 6(a) shows a perspective sectional view and FIG. 6(b) shows a front side sectional view, each in a sectional plane perpendicular to one of the translational movement direction,

FIG. 7 is a perspective exploded view of a second piezoelectric linear drive for a linear or rotary table according to the invention having a different spring element,

FIGS. 8(a) and 8(b) are perspective views of the piezoelectric linear drive of FIG. 7 in an assembled state, wherein FIG. 8(a) shows a perspective external view of the linear drive and FIG. 8(b) shows a perspective sectional view of the linear drive, each from a similar viewing direction,

FIGS. 9(a) and 9(b) are perspective views of a conventional linear or rotary table having the piezoelectric linear drive of FIG. 8, wherein FIG. 9(a) shows the linear table and FIG. 9(b) shows the piezoelectric linear drive of FIG. 8.

FIG. 10 is a perspective side view of the linear table from FIG. 9 in an assembled state,

FIG. 11 is a perspective view of a first embodiment of a linear or rotary table according to the invention movable in two dimensions having a piezoelectric linear drive as shown in FIG. 8,

FIG. 12 is a perspective exploded view of the linear or rotary table of FIG. 11,

FIG. 13 is a second perspective exploded view of the linear or rotary table of FIG. 11,

FIG. 14 is a perspective view of a second embodiment of a linear or rotary table movable in two dimensions according to the invention,

FIG. 15 is a perspective exploded view of the linear or rotary table of FIG. 14.

FIG. 16 is a top view of the linear or rotary table of FIG. 14 without the upper slider plate,

FIG. 17 is a perspective exploded view of a second variant of the linear or rotary table according to the invention from FIG. 14,

FIG. 18 is a top view of the second variant of the linear or rotary table from FIG. 17 without upper and central slider plates,

FIG. 19 is a perspective exploded view of a third variant of the linear or rotary table according to the invention from FIG. 14,

FIG. 20 is a top view of the third variant of the linear or rotary table from FIG. 19 without upper slider plate,

FIG. 21 is a perspective view of a third embodiment of a linear or rotary table movable in two dimensions according to the invention,

FIG. 22 is a perspective exploded view of the linear or rotary table of FIG. 21,

FIG. 23 is a partially free-cut perspective view of the linear or rotary table from FIG. 21,

FIG. 24 is a perspective view of the upper slider plate of the linear or rotary table of FIG. 21,

FIG. 25 is a perspective view of a fourth embodiment of a linear or rotary table movable in two dimensions according to the invention,

FIG. 26 is a perspective exploded view of the linear or rotary table of FIG. 25,

FIG. 27 is a partially free cut perspective view of the linear or rotary table of FIG. 25, and

FIG. 28 is a perspective view of the upper slider plate of the linear or rotary table of FIG. 25.

### DETAILED DESCRIPTION

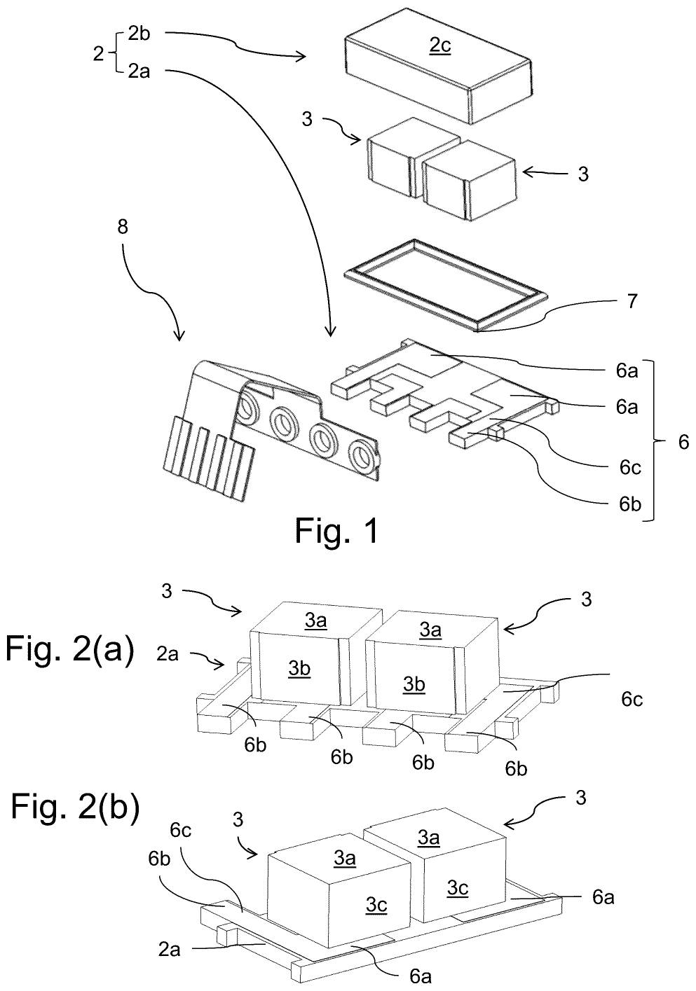

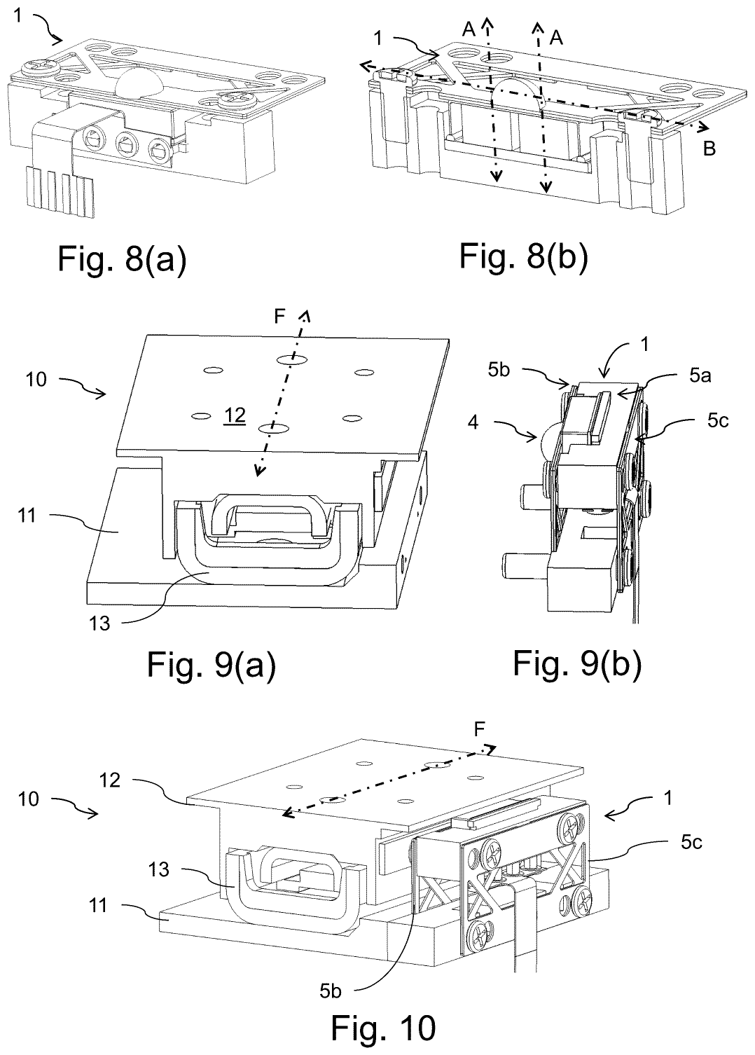

FIGS. 1 to 10 describe various encapsulated piezoelectric linear drives and their use in conventional linear or rotary tables, wherein these encapsulated piezoelectric linear drives are preferably also used in the various embodiments of the linear or rotary tables movable in two dimensions according to the invention in order to enable robust operation independent of the ambient conditions with high positional accuracy and stability despite a structure open across the planes of movement of these linear or rotary tables according to the invention. As can be seen in FIG. 1, such piezoelectric linear drives 1 comprise identical electromechanical actuators 3, which are configured approximately in the shape of a cube and consist of a plurality of alternately arranged piezoelectric layers and layer electrodes (so-called multilayer structure). The layer electrodes between the piezoelectric layers are alternately connected with side electrodes 3b, 3c of different polarity, which are arranged at the front and rear end faces of the actuators 3. However, it is also conceivable to use actuators that have electrodes only on their top and bottom sides or on two opposite sides, and thus there are no internal electrodes as in a multilayer structure. Such actuators, however, require higher electrical voltages to drive them.

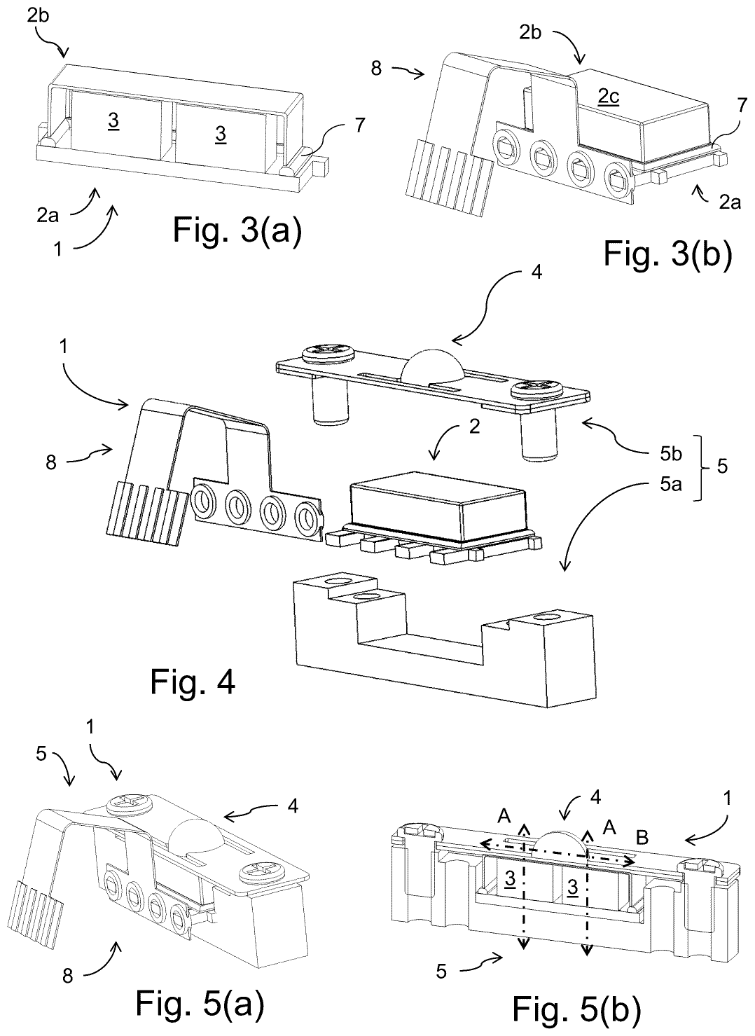

The actuators 3 are arranged mirror-symmetrically next to each other in a hermetically sealed housing 2 and can have electrical control voltages applied to them from outside the housing 2 via a conductor structure 6. The housing 2 comprises as the lower housing part 2a a planar, essentially rectangular plate, on the upper side of which the conductor structure 6 for electrical connection of the actuators 3 is located. This conductor structure 6 comprises inside housing connection points 6a for the side electrodes 3b, 3c of the actuators 3 and outside housing connection points 6b. The connection points 6b provided on the outside of the housing 2 and the connection points 6a on the inside housing side are connected to each other via intermediate conductor paths 6c. In the present case, the upper housing part 2b is configured as an open hollow body in the form of a cuboid lid. This housing cover defines in the interior a receptacle or cavity for the two actuators 3. A circumferential sealing ring 7 is located between the lower housing part 2a and the upper housing part 2b. Instead of a present sealing ring 7, the two housing parts 2a, 2b can also be connected and sealed by a curing adhesive. In the assembled state, explained below with reference to FIGS. 3(a) to 5, the lower housing part 2a and the upper housing part 2b are pressed against each other with the sealing ring 7 clamped in place, as shown in FIGS. 3(a) and 3(b), so that the housing 2 is hermetically sealed. Since the housing partition between the lower housing part 2a and the upper housing part 2b lies exactly in one plane, a particularly simple sealing of the housing 2 can be achieved here.

On the closed upper side of the upper housing part 2b there is an elastic membrane 2c which, as shown in FIG. 3(a), is in contact with the upper side 3a of the actuators 3 when the housing 2 is assembled. The elastic membrane 3c is deformed by the actuators 3 when they are electrically controlled. In the assembled state, the housing 2 has an approximately cuboidal outline, wherein the outside housing connection points 6b project laterally from the housing 2 in the plane of the lower housing part 2a. A flexible printed circuit board 8 can be connected to these outside housing connection points 6b, as shown in FIG. 3(b), or connected having a fixed connection. Such a flexible printed circuit board 8 has a conductor structure communicating with the conductor structure 6 on the lower housing part 2a for having an electrical control voltage applied to the actuators 3.

FIG. 4 shows an exploded view of the piezoelectric linear drive 1, comprising the drive unit consisting of the housing 2 and the actuators 3, a bearing structure 5 configured as a frame, and the flexible printed circuit board 8. In the present case, the bearing structure 5 configured as a frame consists of an approximately C-shaped support 5a having a longer central leg and two shorter side legs. The central leg of the support 5a forms a support for the drive unit. The shorter side legs of the support 5a have openings at the top, i.e. on the side facing away from the central leg, to which a spring element 5b in the form of a planar sheet metal strip provided with an actuating element 4 can be screwed by means of screw bolts. In the assembled state, the housing 2 is clamped between the support 5a and the spring element 5b. In this case, the actuating element 4 is a hemispherical friction nose, which rests with its flat side centrally on the upper side of the spring element 5b and faces away from this spring element 5b with its hemispherical lateral surface. To increase the strength of the arrangement, the housing 2 can additionally be bonded to the support 5a and/or to the spring element 5b.

The bearing structure 5 is dimensioned in such a way that, in the assembled state of the piezoelectric linear drive 1, the spring element 5b rests exactly on the elastic diaphragm 2c of the housing 2, as is shown illustratively in FIGS. 5(a) and 5(b). When the actuators 3 are electrically controlled, the deflection of the actuators 3 along the lines A is first transmitted to the elastic diaphragm 2c, and from there to the spring element 5b, which is spring-biased with respect to the diaphragm 2c, in order to set the actuating element 4 in motion along the line B in a linear direction (back and forth). Depending on the control of the actuators 3, different movement patterns of the actuating element 4 can be displayed. In one operating mode of the piezoelectric linear drive 1, for example, the actuators 3 can be controlled in such a way that the actuating element 4 drives a component coupled thereto that is to be driven in a direction along the line B by stick-slip effect. In another operating mode of the piezoelectric linear drive 1, the actuating element 4 drives the component to be driven in an opposite direction along the line B. In each of these operating modes, one of the actuators 3 is expanded along line A as a result of the electrical drive, and the other of the actuators 3 is contracted along line A. Due to the electrically induced deformations of the actuators 3, the actuating element 4 tilts along the line B toward one end of the support 5a in the direction of the contracted actuator 3. In the driving direction of the element to be driven along the line B, the movement of the actuating element 4 is slower than in the opposite direction, so that the actuating element 4 entrains the element to be driven in the driving direction by static friction in the sticking phase, and slides along the element to be driven in the opposite direction in the sliding phase due to the inertia of the element to be driven. The stick-slip effect as well as the function and mode of operation of corresponding piezoelectric linear drives 1 are basically known and will therefore not be explained in detail.

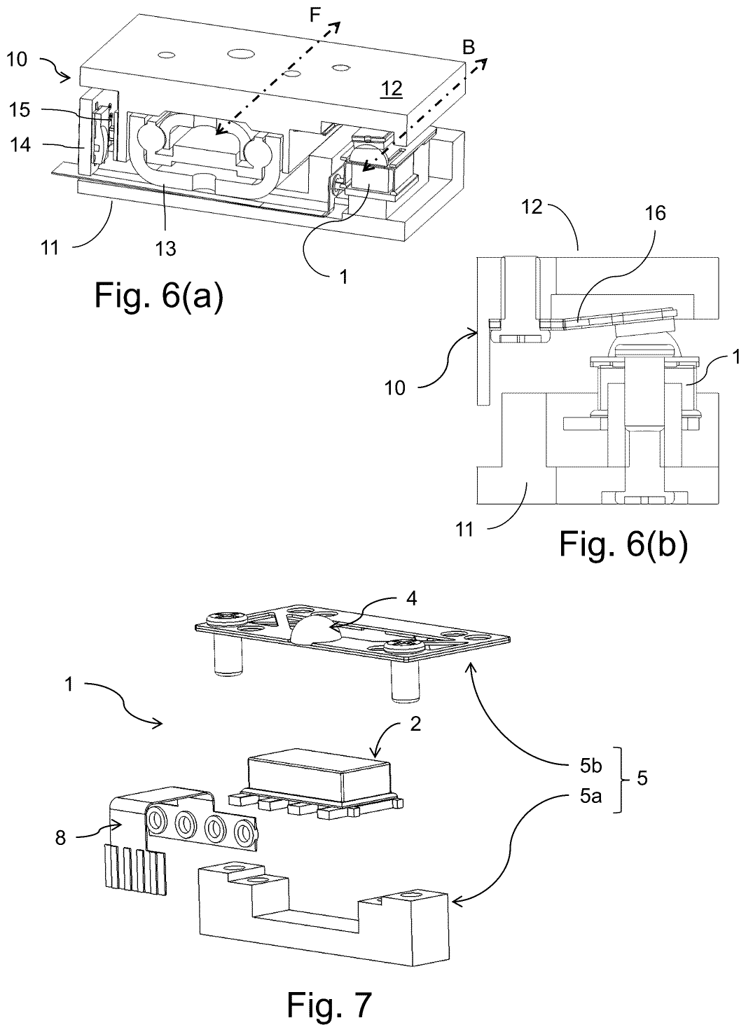

In an arrangement known per se, such a piezoelectric linear drive 1 can be used in a conventional linear or rotary table 10. In this case, the piezoelectric linear drive 1, as shown in FIGS. 6(a) and 6(b), is mounted on a stator 11 in such a way that the drive direction B is aligned parallel to a guide direction F of the slider 12 predetermined by a linear guide 13. A position of the slider 12 relative to the stator 11 is determined via a position encoder 14 and a position sensor 15. This information is used to control the actuators 3 of the piezoelectric linear drive 1 to control the position of the slider 12 relative to the stator 11.

According to the illustration in FIG. 6(b), the slider 12 is spring-loaded relative to the stator 11 or relative to the actuating element 4 of the piezoelectric linear drive 1. For this purpose, there is a protruding spring plate 16 on the underside of the slider 12, which is screwed to the slider 12 at one end thereof and is in contact with the actuating element 4 of the piezoelectric linear drive 1 with its free end. This spring plate 16 enables the slider 12 to absorb the driving forces of the piezoelectric linear drive 1 exerted by the actuating element 4 particularly well.

The second embodiment example, which is described below with reference to FIGS. 7 to 10 is essentially based on the first embodiment example and comprises largely identical features. To avoid repetition, these identical features are indicated in the figures having identical reference signs. For an explanation of these reference signs, reference is made to the first embodiment example in FIGS. 1 to 6(b). The main differences from the first embodiment example are described in detail below.

In FIGS. 7 to 10, a further embodiment of the encapsulated piezoelectric linear drive 1 is shown. Differing from the above-described embodiment, the spring element 5b of the bearing structure 5 of the piezoelectric linear drive 1 comprises a different embodiment. This spring element 5b of the bearing structure 5 is not only configured as a sheet metal strip having approximately the same width as the support 5a, but protrudes significantly over the support 5a on one side. On this protruding side of the spring element 5b, the piezoelectric linear drive 1 is spring-mounted on the stator 11 of the linear drive 10. To increase stability and spring action, a corresponding spring element 5c can be provided on the underside of the support 5a, corresponding to the spring element 5b on the upper side of the support 5a, as can be seen in the illustration of a conventional linear or rotary table 10 in FIGS. 9(a) and 10. By means of material recesses and notches, the weight of such spring elements 5b, 5c can be minimized in applications of the findings of lightweight construction technology while maintaining virtually unchanged stability.

Deviating from the first embodiment example, the spring element 5b of the piezoelectric linear drive 1 in particular thus generates not only a resilient bias of the actuating element 4 towards the actuators 3, but also a resilient bias of the actuating element 4 towards the slider 12. Consequently, this arrangement improves both the power transmission between the actuators 3 and the actuating element 4, and the power transmission between the actuating element 4 and the slider 12.

The principle of an encapsulated piezoelectric linear drive 1, in particular a piezoelectric inertial or resonant drive, in which at least two actuators 3 (e.g. piezoelectric multilayer actuators 3) are arranged in a housing 2 on a base plate 2a, and a friction-coupled actuating element 4, which is arranged on the upper side of this housing 2, protects the actuators 3 from the dust-like abrasion generated during sliding contact between the slider 12 and stator 11 of a linear or rotary table movable in two dimensions, as well as from lubricant that may be used in the linear or rotary guides. The special feature of these encapsulated piezoelectric linear drives 1 is that the transmission of force between the actuators 3 and the friction-coupled actuating element 4 is not affected by the encapsulation of the actuators 3 in the housing 2. Another secondary function of the housing 2 is to dissipate heat generated by the actuators 3 during operation to the environment. The housing 2 can provide good protection against oxidation for the piezoelectric layers and layered electrodes, as well as the inside housing connection electrodes 6a of the actuators 3. Accordingly, the insulation of the contact points of the actuators 3 and electrodes from the environment prevents oxidation caused by dust or moisture even under demanding environmental conditions. Insulation of the actuators 3 thus provides a significant advantage for reliable operation and long life of the piezoelectric linear drive 1.

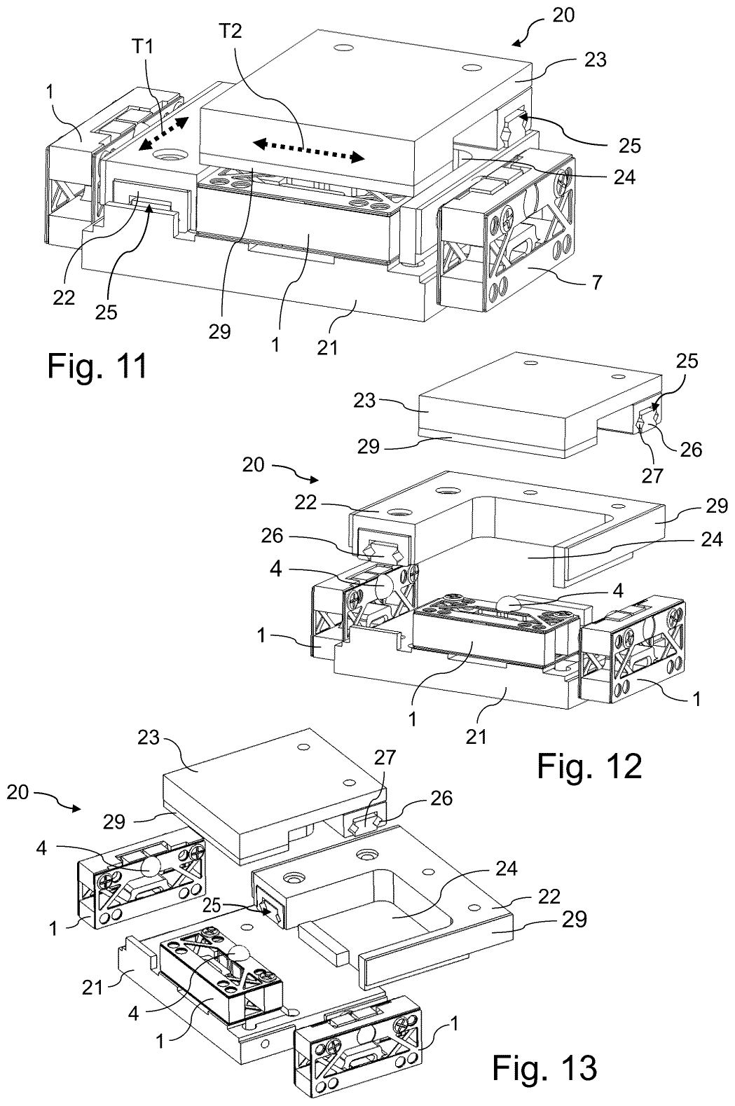

FIGS. 11 to 28 show various embodiments of linear or rotary tables 20 movable in two dimensions according to the invention. Such linear or rotary tables 20 movable in two dimensions consist essentially of three layers, a stator 21 acting as a lower layer or base plate, a central slider plate 22 and an upper slider plate 23, which are each arranged one above the other and define two movement planes therebetween in order to move the upper slider plate 22 in relation to the stator 21 in two independent translational movement directions T1, T2 or two independent rotary movement directions R1, R2. In this case, only the upper slider plate 23 moves in both independent translational movement directions T1, T2 or rotary movement direction R1, R2. For each of the two independent translational movement directions T1, T2 or two independent rotary movement directions R1, R2, at least one piezoelectric linear drive 1 is provided, which is fixed to the stator 21 by its frame 5 or frame lower part 5a, while the actuating elements 4 of the piezoelectric linear drives 1 act on the central slider plate 22 or the upper slider plate 22 to move the upper slider plate 22 relative to the stator 21 in the two independent translational movement directions T1, T2 or two independent rotary movement directions R1, R2. Since the frames 5 of the piezoelectric linear drives 1 are fixedly connected to the stator 21 of the linear or rotary table 20 movable in two dimensions, the connecting lines of the piezoelectric linear drives 1 can be fixedly laid, so that in an embodiment of the linear or rotary table 20 according to the invention, a flexible connecting line for the piezoelectric linear drives 1 for moving the upper slider plate 23 can be completely dispensed with.

The perspective view in FIG. 11 shows a linear table 20 movable in two dimensions according to the invention. As can be seen clearly from the exploded views in FIGS. 12 and 13, this linear table 20 movable in two dimensions comprises a stator 21 on which three piezoelectric linear drives 1 are arranged, as well as a central slider plate 22 and an upper slider plate 23. The piezoelectric linear drives 1 are each fixedly mounted on the stator 21 by their frame 5, while the actuating element 4 acts on the central slider plate 22 or the upper slider plate 23 to move the upper slider plate 23 in two independent translational movement directions T1, T2. The two piezoelectric linear drives 1 arranged at the outer end faces of the stator 21 act on the sides of the central slider plate 22 to move the central slider plate 22 in a first translational movement direction T1. The piezoelectric linear drive 1 arranged therebetween in the center of the stator 21 acts with its actuating element 4 through an opening 24 in the central slider plate 22 directly on the upper slider plate 23 to move the upper slider plate 23 in a second translational movement direction T2 independently of the movement or position of the central slider plate 22.

When the upper slider plate 23 is moved via the piezoelectric linear drive 1, which is arranged centrally on the stator 21 and electrically energized, the central slider plate 22 is held in position in the first translational movement direction T1 by the two piezoelectric linear drives 1 arranged laterally, provided that these two piezoelectric linear drives 1 are not electrically energized. In a case where all piezoelectric linear drives 1 attached to the stator 21 are electrically energized, the upper slider plate 23 moves simultaneously in the two independent translational movement directions T1, T2. When the two laterally arranged piezoelectric linear drives 1 are exclusively energized to move the central slider plate 22 only along the first translational movement direction T1, this movement of the central slider plate 22 takes place against an inhibition by the frictional contact between the actuating element 4 of the piezoelectric linear drive 1 arranged in the center of the stator 21 and the friction plate 29 of the upper slider plate 23. By electrically exciting both actuators 3 of this piezoelectric linear drive 1, which is responsible for moving the upper slider plate 23 in the second translational movement direction T2, with the same voltage signal, preferably a sinusoidal or sawtooth-shaped voltage signal, i.e. with in-phase control of the two actuators 3 acting against each other, the frictional inhibition between the actuating element 4 and the friction plate 29, which otherwise occurs during breakaway and during movement, can be reduced.

For safe and backlash-free movement of the upper slider plate 23 in the two independent translational movement directions T1, T2, both the central slider plate 22 and the upper slider plate 23 are provided with a guide 25. The guide 25 has a guide rail 26 and a guide receptacle 27 in each case. For axial guidance of the central slider plate 22 in the first independent translational movement direction T1, a guide rail 26 is fixed on the stator 21 and received in a corresponding guide receptacle 27 in the central slider plate 22, and for axial guidance of the upper slider plate 23 in the second independent translational movement direction T2, a guide rail 26 is fixed on the central slider plate 22 and received in a guide receptacle 27 in the upper slider plate 22.

Furthermore, friction plates 29 are provided on the end faces of the central slider plate 22 and on the underside of the upper slider plate 23, which are in contact with the actuating elements 4 of the respective piezoelectric linear drives 1 and enable safe movement of the central slider plate 22 and the upper slider plate 23 in the two independent translational movement directions T1, T2. In this context, the friction plates 29 may be preloaded with respect to the actuating elements 4.

The particular linear arrangement of the three piezoelectric linear drives 1 on the stator 21 makes it possible to construct a very slim linear table 20 movable in two dimensions and does not require any moving connecting cables for supplying the piezoelectric linear drives 1. Further, the completely separate action of the individual piezoelectric linear drives 1 on the central slider plate 22 and the upper slider plate 23 enables complete decoupling of the movement of the upper slider plate 23 in the two independent translational movement directions T1, T2.

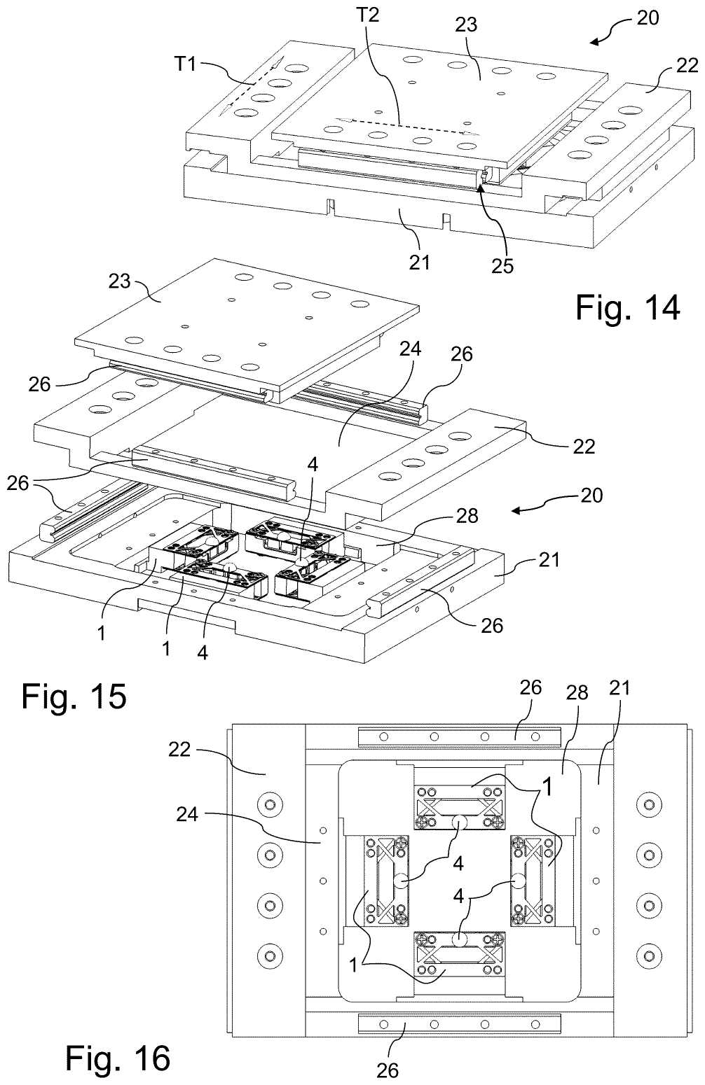

FIGS. 14 to 16 show a second embodiment of a 2-dimension linear table 20 according to the present invention in a first variant. This linear table 20, which is movable in two dimensions, again has a stator 21, a central slider plate 22 and an upper slider plate 23 as a base plate. As shown by the perspective exploded view in FIG. 15, four piezoelectric linear drives 1 are fixedly arranged on this stator 21 in a central recess 28 in the base plate or stator 21 in order to move the upper slider plate 23 in two independent translational movement directions T1, T2 via the respective actuating elements 4. In doing so, the actuating elements 4 of the piezoelectric linear drives 1 each act directly on the underside of the upper slider plate 23 or on a friction plate 29. When electrically excited via the actuating elements 4, the piezoelectric linear drives 1 arranged in the direction of the end face of the stator 21 move the central slider plate 22 together with the upper slider plate 23 in the first translational movement direction T1, while the piezoelectric linear drives 1 arranged on the longitudinal side of the stator 21 in the recess 28 move only the upper slider plate 23 in the second translational movement direction T2. For secure axial guidance of the central slider plate 22 and the upper slider plate 23, again guides 25 are provided here, which are configured as interengaging guide rails 26.

As can be seen clearly in the top view of the linear table 20 movable in two dimensions without the upper slider plate 23 in FIG. 16, the actuating elements 4 of the piezoelectric linear drives 1 arranged in the recess 28 of the stator act exclusively on the upper slider plate 23, so that the movement of the central slider plate 22 in the first translational movement direction takes place only indirectly via the upper slider plate 23 coupled to the central slider plate 22 by means of the guide rails 26 of the guide 25. Also in this variant of a linear table movable in two dimensions according to the invention, the arrangement of the piezoelectric linear drives 1 corresponding to the translational movement directions T1, T2 makes it possible to decouple the movement of the upper slider plate 23 in the two independent translational movement directions T1 and T2 via a selective electrical control of the piezoelectric linear drives 1. The arrangement of the piezoelectric linear drives 1 in the recess 28 in the stator 21 and the direct drive of the piezoelectric linear drives 1 via the actuating elements 4 bearing against the upper slider plate 23 results in a very flat structure of a linear table 20 movable in two dimensions according to the invention.

Again, when the two laterally arranged piezoelectric linear drives 1 are controlled solely to move the central slider plate 22 along the first translational movement direction T1, the two actuators 3 of the two central piezoelectric linear drives 1, which are arranged on the longitudinal sides of the stator 21 for moving upper slider plate 23 in the second translational movement direction T2, can again be excited with an identical voltage signal to reduce the frictional contact between the associated actuating elements 4 and the upper slider plate 23.

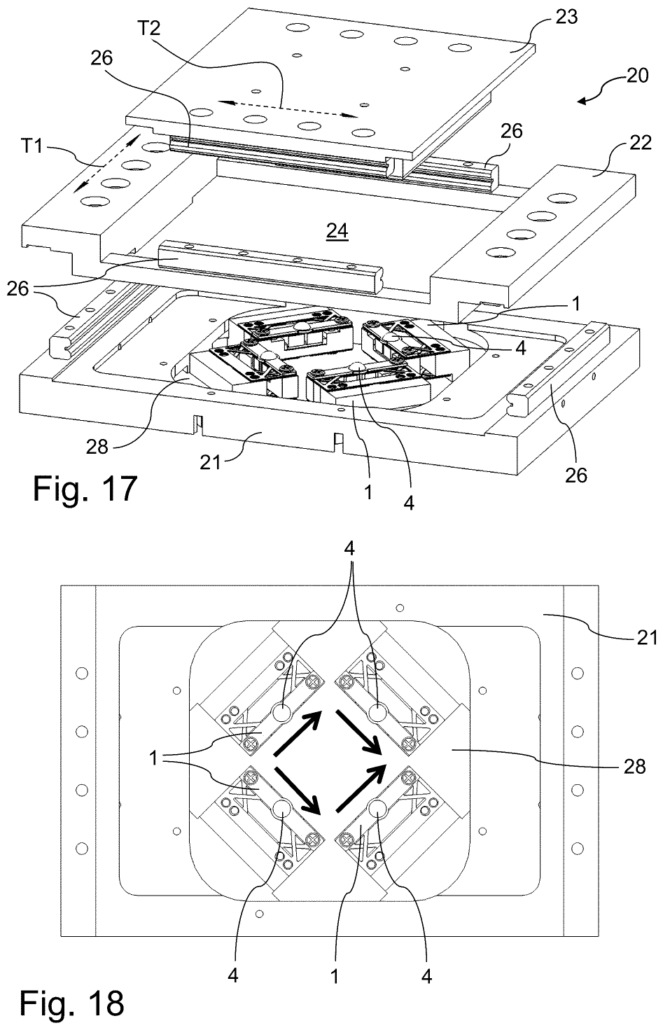

FIGS. 17 and 18 show a second variant of the embodiment of a linear table 20 movable in two dimensions according to the invention as shown in FIG. 14. In the perspective exploded view in FIG. 17 it can be clearly seen that in this variant the four piezoelectric linear drives 1 are arranged in the recess 28 of the stator 21 rotated by 45° with respect to the translational movement directions T1 and T2. Here again, the actuating elements 4 of the piezoelectric linear drives 1 attached to the stator 21 each act directly on the upper slider plate 23, so that a movement of the central slider plate 22 in the first translational movement direction T1 occurs only indirectly via the movement of the upper slider plate 23. Again, the central slider plate 22 is guided in the first and second translational movement directions T1 and T2 by guide rails 26 attached to the stator and the upper slider plate 23 is guided by guide rails 26 attached to the central slider plate 22. As can be seen in the top view in FIG. 18 shown without the central slider plate 22 and the upper slider plate 23, two of the piezoelectric linear drives 1 arranged opposite each other in the recess 28 of the stator 21 move in a direction that is inclined by 45° to the translational movement directions T1, T2. Therefore, the movement contributions of the individual piezoelectric linear drives 1 are added or subtracted to result in a movement of the upper slider plate 23 in the first and second translational movement directions T1 and T2. For movement along only one of the translational movement directions T1 and T2, all four piezoelectric linear drives 1 are actuated simultaneously. For the oscillation directions of the associated actuating elements 4, indicated in FIG. 18 by arrows, a movement along the translational movement direction T2 results. In contrast, a control in which the direction of oscillation of two actuating elements 4 opposite each other runs in an opposite direction, results in a movement of the upper slider plate 23 and the central slider plate 22 along the translational movement direction T1.

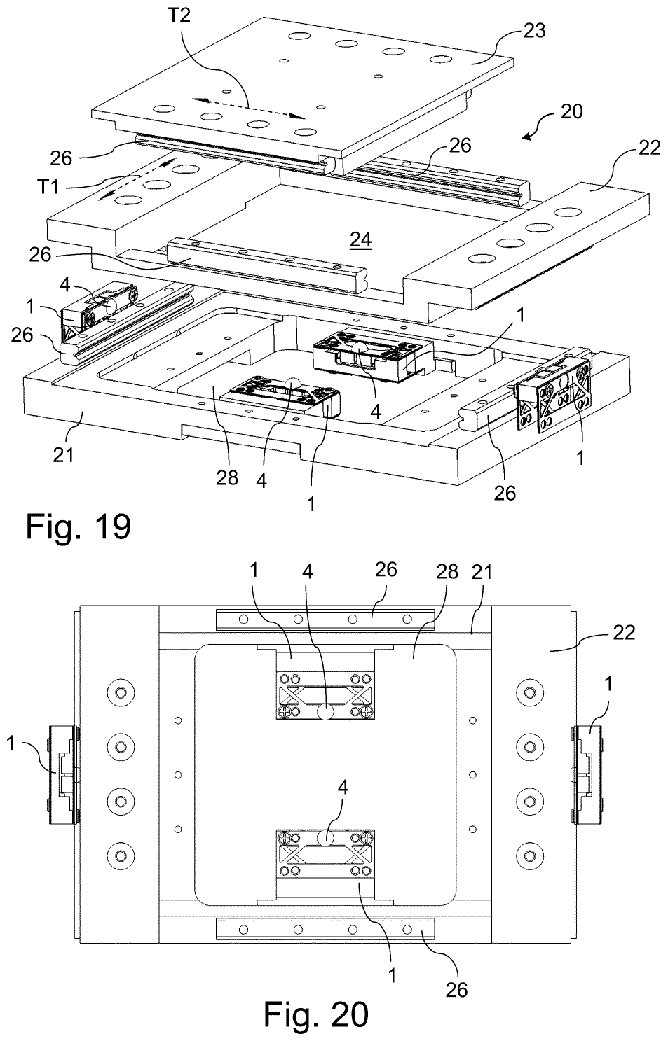

FIGS. 19 and 20 show a further variant of the embodiment of a 2-dimension linear table 20 according to the invention shown in FIG. 14. In contrast to the two previous variants, the two piezoelectric linear drives 1 for moving the central slider plate 22 in the first independent translational movement direction T1 are arranged at the end faces of the stator 21 and act directly on the central slider plate 22 having their actuating elements 4. As can be seen in the perspective exploded view in FIG. 19, only two piezoelectric linear drives 1 are now provided in the recess 28 of the stator 21, the actuating elements 4 of which act on the underside of the upper slider plate 23 through the opening 24 in the central slider plate 22 to move the upper slider plate 23 in the second independent translational movement direction T2. Accordingly, the movement of the upper slider plate 23 in the first translational movement direction T1 occurs indirectly via the movement of the central slider plate 22. When the two laterally arranged piezoelectric linear drives 1 are controlled purely for a movement of the central slider plate 22 along the first translational movement direction T1, the two actuators 3 of the two piezoelectric linear drives 1 arranged in the recess 28 of the stator 21 can be excited with an identical voltage signal in order to reduce the friction between the associated actuating elements 4 and the upper slider plate 23. Again, guide rails 26 are provided on the stator 21 to guide the central slider plate 22 in the first translational movement direction T1, and guide rails 26 are provided on the central slider plate 22 to guide the upper slider plate 23 in the second translational movement direction T2. Despite the direct movement of the central slider plate 22 via the laterally arranged piezoelectric linear drives 1 in the first translational movement direction T1, this variant again permits a very flat structure of a linear table 20 movable in two dimensions according to the invention, as well as a decoupling of the movement of the upper slider plate 22 in the first and second translational movement directions T1 and T2.

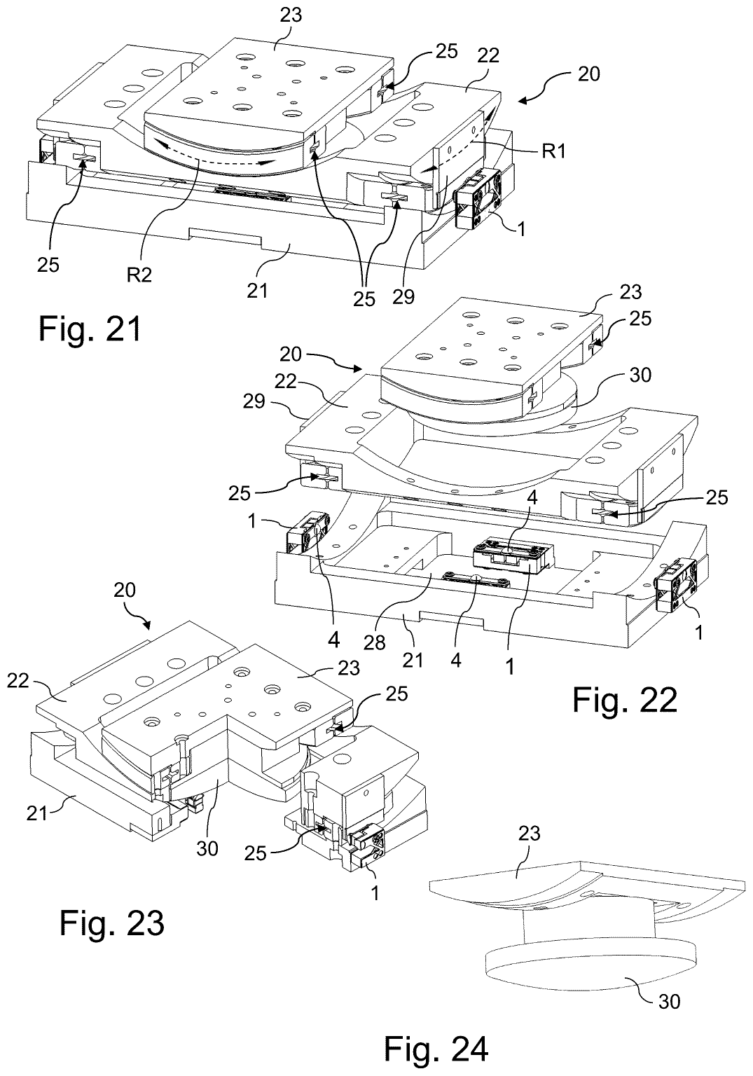

FIGS. 21 to 24 show a further embodiment of a linear or rotary table 20 movable in two dimensions according to the invention. This 2-dimension rotary table 20 configured for a rotational or tilting movement permits a movement of the upper slider plate 22 in two independent rotational movement directions R1, R2, i.e. in each case a movement about one of the three mutually independent rotational axes of a fixed body in free space. As can be seen in the perspective exploded view in FIG. 22 and the partially free-cut perspective view in FIG. 23, this rotary table 20 movable in two dimensions comprises a stator 21 serving as a base plate, a central slider plate 22 arranged above it, and an upper slider plate 23 arranged above it. Here, the guide 25 arranged between the stator 21 and the central slider plate 22 permits safe movement of the central slider plate 22 and the upper slider plate 23 coupled thereto in the first rotary movement direction R1, and the guide 25 arranged between the central slider plate 22 and the upper slider plate 23 permits safe movement of the upper slider plate 23 in the second rotary movement direction R2.

Furthermore, two piezoelectric linear drives 1 are arranged at the end faces of the stator 21, wherein the piezoelectric linear drives 1 are fixedly connected to the stator 21 via the frame 5 and their actuating elements 4 act on corresponding friction plates 29 at the end faces of the slider plates 22 to move the central slider plate 22 in the first rotary movement direction R1. Together with the central slider plate 22, the upper slider plate 23 also moves indirectly in the first rotary movement direction R1. Two further piezoelectric linear drives 1 are arranged in a recess 28 of the stator 21, which extend in the longitudinal direction of the stator 21. These piezoelectric linear drives 1, which are fixedly connected to the stator 21, act directly on the upper slider plate 23 via their actuating element 4 through an opening 24 in the central slider plate 22 to move it in the second rotary movement direction R2.

In order to move the upper slider plate 23 in the second rotary movement direction R2, despite the movement in the first rotary movement direction R1 coupled to the central slider plate 22 via the piezoelectric linear drives arranged in the recess 28 of the stator 21, the upper slider plate 23 has a spherical or spherical friction head 30 on its underside which, despite a rotation of the upper slider plate 23 in the first rotational movement direction R1, always ensures a secure contact with the actuating elements 4 of the internal piezoelectric linear drives 1 and enables a rotation of the upper slider plate 23 in the second translational movement direction R2. Again, if the two laterally arranged piezoelectric linear drives 1 are controlled solely to move the central slider plate 22 in the first rotary movement direction R1, the two actuators 3 of the two piezoelectric linear drives 1 arranged in the recess 28 of the stator 21, which are arranged on the longitudinal sides of the stator 21 for moving the upper slider plate 23 in the second rotary movement direction R2, can be excited having the same voltage signal in order to reduce the frictional contact between the associated actuating elements 4 and the spherical or spherical friction head 30. This design of a rotary table 20 movable in two dimensions according to the invention allows the provision of very flat rotary and tilting tables and still allows a safe and accurate positioning of the upper slider plate 23 as well as the objects arranged thereon in two translational movement directions R1, R2.

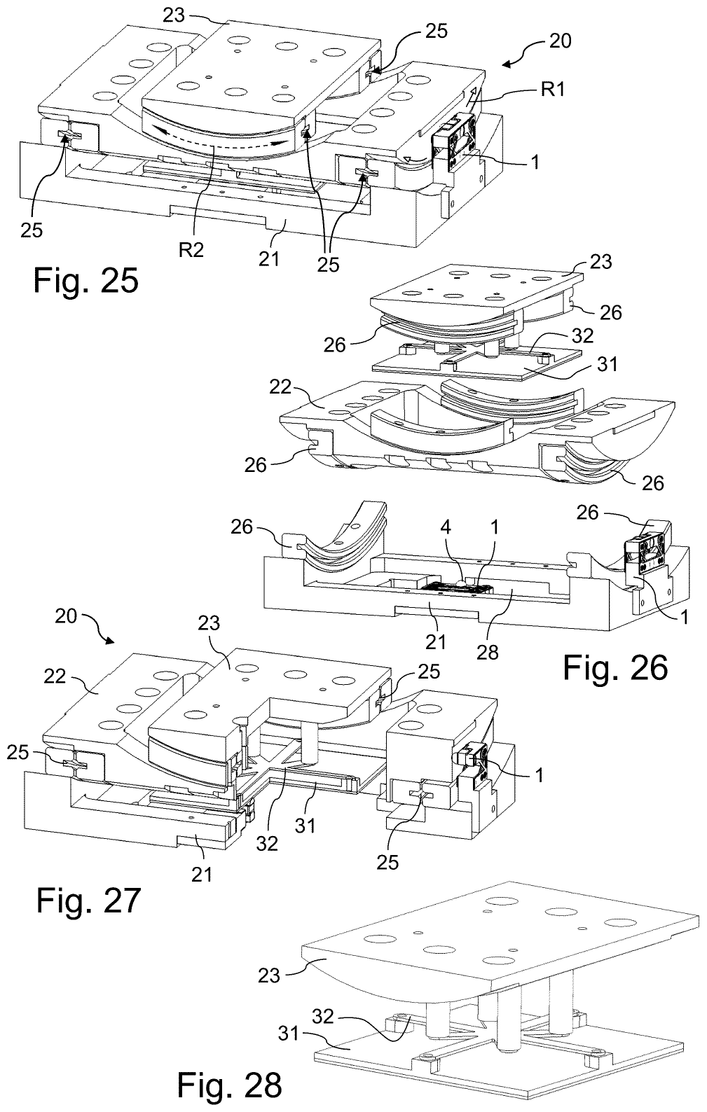

Another variant of a rotary table 20 rotatable in two dimensions in two independent rotary movement directions R1, R2 according to the present invention is shown in FIGS. 25 to 28. Here, the structure of the rotary table 20 having a stator 21, a central slider plate 22 and an upper slider plate 23 arranged one above the other and defining two planes of motion therebetween, as well as the piezoelectric linear drives 1 arranged externally at the end faces of the stator 21 for moving the central slider plate 22 in the first rotary movement direction R1, as well as the guides 25 between the stator 21 and the central slider plate 22 and between the central slider plate 22 and the upper slider plate 23, corresponds to the embodiment shown in FIGS. 21 and 22. In contrast, this rotary table 20 movable in two dimensions has only a piezoelectric linear drive 1 fixedly connected to the stator 21 in the recess 28 of the stator 21.

In order to transfer a movement of the actuating element 4 of this piezoelectric linear drive 1 in a linear direction into a movement of the upper slider plate 23 in the second rotary movement direction R2, a flat friction plate 31 is provided on the underside of the upper slider plate 23, which is connected to the underside of the upper slider plate 23 via a flat bending spring 32. When the upper slider plate 23 is moved in the second rotary movement direction R2, the flat bending spring 32 follows with a corresponding curvature so that an unchanged frictional contact is maintained between the actuating element 4 of the piezoelectric linear drive 1 and the friction plate 31 connected to the upper slider plate 23. When the two piezoelectric linear drives 1 arranged at the end faces of the stator 21 are driven only for a movement of the central slider plate 22 in the first rotary movement direction R1, the two actuators 3 of the piezoelectric linear drive 1 arranged in the recess 28 of the stator 21 can be excited with an equal voltage signal to reduce the friction inhibition between the associated driving elements 4 and the friction plate 31 of the upper slider plate 23. The piezoelectric linear drives 1 arranged at the outer end faces of the stator 21 for moving the central slider plate 22 in the first rotary movement direction can also be arranged inside the recess 28 of the stator and from there move the central slider plate 22 in the first rotary movement direction R1.

1-18. (canceled)

19. A linear or rotary table movable in two dimensions comprising:
a stator;
at least one upper slider plate movable relative to the stator in two independent translational directions or two independent rotary directions;
at least two piezoelectric linear drives for moving the upper slider plate in the two translational directions or two rotary directions; and
a central slider plate arranged between the stator and the upper slider plate,
wherein the at least two piezoelectric linear drives are each attached to the stator and configured to move the upper slider plate in the two translational directions or two rotary directions, and
wherein at least one piezoelectric linear drive attached to the stator is in contact with the upper slider plate through an opening in the central slider plate and configured to move the upper slider plate in a first translational direction or a first rotary direction.

20. The linear or rotary table movable in two dimensions according to claim 19,
wherein the at least two piezoelectric linear drives attached to the stator are arranged at an angle relative to each other, preferably at an angle of 90° to each other.

21. The linear or rotary table movable in two dimensions according to claim 19,
wherein at least one guide for the upper slider plate is provided and configured to guide the upper slider plate relative to the stator in at least one translational direction or at least one rotary direction.

22. The linear or rotary table movable in two dimensions according to claim 21,
wherein a guide is provided between the stator and the central slider plate and between the central slider plate and the upper slider plate, respectively.

23. The linear or rotary table movable in two dimensions according to claim 22,
wherein the guide between the stator and the central slider plate and/or the guide between the central slider plate and the upper slider plate is configured as guide rails, and
wherein the guide rails are provided each on two opposite sides of the stator and/or the central slider plate and/or respectively of the central slider plate and/or the upper slider plate.

24. The linear or rotary table movable in two dimensions according to claim 19,
wherein the upper slider plate and/or the central slider plate has a resilient force absorbing device configured to absorb a driving force of the piezoelectric linear drives.

25. The linear or rotary table movable in two dimensions according to claim 19,
wherein the at least two piezoelectric linear drives are configured as at least two piezoelectric frictional contact actuators.

26. The linear or rotary table movable in two dimensions according to claim 25,
wherein the at least two piezoelectric frictional contact actuators each have at least one actuating element configured as a friction element, and
wherein the friction elements are in frictional contact with the upper slider plate or with the central slider plate and the upper slider plate and configured to move the upper slider plate in the two translational directions or two rotary directions.

27. The linear or rotary table movable in two dimensions according to claim 19,
wherein the at least two piezoelectric linear drives are configured as at least two encapsulated piezoelectric linear drives, in particular configured as encapsulated piezoelectric inertial or resonance drives, and having a housing, at least two actuators arranged within the housing and comprising an electromechanical material arranged inside the housing, each of which generates a deflection when excited by an electric control voltage, and a driving element arranged outside the housing, wherein an elastic wall portion of the housing, which is elastically deformed by the deflection of the actuators, couples the actuators and the driving element to each other so that the driving element is set in motion by the deflection of the actuators.

28. The linear or rotary table movable in two dimensions according to claim 27,
wherein the housing comprises two or more housing parts, wherein the housing parts are connected to one another with the interposition of at least one sealing element.

29. The linear or rotary table movable in two dimensions according to claim 28,
wherein a first housing part of the two or more housing parts is configured as a planar plate and a second housing part of the two or more housing parts is configured as an open hollow body closable by the planar plate and having a cavity for receiving the actuators, wherein the open hollow body comprises the elastic wall portion, which is aligned parallel to the first housing part in a closed state of the housing.

30. The linear or rotary table movable in two dimensions according to claim 26,
wherein the encapsulated piezoelectric linear drives have an electrical conductor structure having inside housing connection points and outside housing connection points, which are connected by conductor paths, wherein the actuators are electrically connected to the inside housing connection points, and wherein the outside housing connection points are configured to connect to a control device for controlling the actuators.

31. The linear or rotary table movable in two dimensions according to claim 30,
wherein the inside housing connection points, the outside housing connection points and the conductor paths extend in the same plane.

32. The linear or rotary table movable in two dimensions according to claim 26,
wherein the encapsulated piezoelectric linear drives comprise a support and a spring member urging the housing against the support.

33. The linear or rotary table movable in two dimensions according to claim 32,
wherein the support and the spring member form a frame enclosing the housing.

34. A method for moving a linear or rotary table movable in two dimensions, the linear or rotary table comprising a stator, at least one upper slider plate which can move relative to the stator in two independent translational directions or two independent rotary directions, a central slider plate arranged between the stator and the upper slider plate, and at least two piezoelectric linear drives attached to the stator and configured to move the upper slider plate in the two translational directions or two rotary directions, wherein at least one piezoelectric linear drive attached to the stator is in contact with the upper slider plate through an opening in the central slider plate and is configured to move the upper slider plate in a first translational direction or a first rotary direction, the method comprising:
adding or subtracting individual motion contributions of all the piezoelectric linear drives attached to the stator to move the upper slider plate in one or both independent translational directions, or respectively in one or both independent rotary directions.

35. The method according to claim 34, wherein the at least two piezoelectric linear drives attached to the stator are inclined at an angle to the two translational directions or to the projections of the two rotational directions, and wherein, for moving the upper slider plate in one of the independent translational directions, or respectively in one of the independent rotary directions, all the piezoelectric linear drives attached to the stator provide a substantial positive or negative motion contribution.

36. The method according to claim 34, wherein the at least two piezoelectric linear drives attached to the stator are arranged parallel to the two translational directions or to the projections of the two rotational directions, and wherein the at least two actuators of at least one piezoelectric linear drive, which does not provide a motion contribution for moving the upper slider plate in one of the independent translational directions, respectively in one of the independent rotary directions, are controlled having the same voltage signal to reduce a friction inhibition between the actuating element of this piezoelectric linear drive and the upper slider plate.

37. The linear or rotary table movable in two dimensions according to claim 27,
wherein the at least two piezoelectric linear drives are configured as at least two encapsulated piezoelectric inertial or resonance drives.

38. The linear or rotary table movable in two dimensions according to claim 20,
wherein the at least two piezoelectric linear drives attached to the stator are arranged at an angle of 90° to each other.
